(19) United States
(12) Patent Application Publication
(10) Pub. No.: US 2026/0048615 A1
(43) Pub. Date: Feb. 19, 2026

(54) MOBILE WHEEL STRUCTURE AND CART

(71) Applicant: TILTA INC., Burbank, CA (US)

(72) Inventors: Shuangqiang YANG, Shenzhen (CN); Wenping ZENG, Shenzhen (CN); Kefeng ZHOU, Shenzhen (CN)

(21) Appl. No.: 19/299,089

(22) Filed: Aug. 13, 2025

(30) Foreign Application Priority Data
Aug. 16, 2024 (CN) 2024220073682

(51) Int. Cl. B60B 33/00; B62B 5/04

(52) U.S. Cl. CPC B60B 33/0057; B60B 33/0068; B60B 33/0078; B62B 5/0433

(57) ABSTRACT

This disclosure discloses a mobile wheel structure and a cart, including a connection assembly and a wheel assembly. The wheel assembly includes a mounting frame, a wheel, and a braking member. The mounting frame is pivotally connected to the connection assembly via a first pivot shaft, with a portion of the mounting frame connected to a wheel bearing, offsetting the wheel bearing from the axial direction of the first pivot shaft. The braking member is movably connected to the mounting frame, with both the braking member and the wheel bearing positioned on the same side of the first pivot shaft. This design simplifies the user's operation of the braking member to brake the wheel during cart usage.

### CROSS-REFERENCE TO RELATED APPLICATIONS

The present application for patent claims priority to and the benefit of pending Chinese Application on No. 2024220073682, filed Aug. 16, 2024, and hereby expressly incorporated by reference herein as if fully set forth below in its entirety and for all applicable purposes.

### TECHNICAL FIELD

The present disclosure pertains to the technical field of expansion accessories, specifically to a mobile wheel structure and a cart.

### INTRODUCTION

Carts are commonly used auxiliary vehicles in daily life, work, outdoor activities, and other scenarios. For instance, users can load photography accessories onto a cart in specific shooting environments.

Traditional carts typically feature a storage body with swivel casters or universal wheels pivotally mounted at the bottom via a movable pivot shaft, enabling cart movement. Due to the wheels' universal mobility, the wheel bearing is usually offset from the pivot shaft's axial direction for eccentricity to ensure swivel functionality. However, in this case, during cart pushing, the universal wheel structure tends to rotate inward beneath the storage body, causing the braking mechanism of the universal wheel structure to also move into the internal space under the storage body, thereby inconveniencing users in operating the braking function.

### BRIEF SUMMARY

Aspects of the present disclosure provide a mobile wheel structure and a cart, addressing the issue where, during cart pushing, the universal wheel structure easily rotates inward beneath a storage body of the cart, causing the braking mechanism of the universal wheel structure to also move under the storage body and causing inconvenience to users in operating the braking function.

Some aspects of the present disclosure provide:

A mobile wheel structure, including:
a connection assembly;
a wheel assembly, including a mounting frame, a wheel, and a braking member. The mounting frame is pivotally connected to the connection assembly via a first pivot shaft, with a portion of the mounting frame extending obliquely to connect to a wheel bearing of the wheel, offsetting the wheel bearing from the axial direction of the first pivot shaft. The braking member is movably connected to the mounting frame, with both the braking member and the wheel bearing positioned on the same side of the first pivot shaft.

This disclosure also provides a cart, including multiple storage platforms, a support column, and the aforementioned mobile wheel structure. The multiple storage platforms include a first storage platform and a second storage platform. One end of the support column is connected to the first storage platform, and the other end is connected to the second storage platform. The connection assembly is connected to a side of the second storage platform opposite to the first storage platform.

In this disclosure, the mounting frame includes an obliquely extending portion, with the braking member and the wheel bearing positioned on the same lateral side of the first pivot shaft. Thus, during use, when the user pushes the cart, the wheel rotates relative to the wheel bearing, and the mounting frame rotates along with the wheel relative to the connection assembly, tilting outward to position the wheel outside the cart. Since the braking member and the wheel bearing are on the same side of the first pivot shaft, the braking member remains outside the cart, simplifying the user's operation of the braking member to brake the wheel.

### BRIEF DESCRIPTION OF THE DRAWINGS

To illustrate the technical solutions in the embodiments or prior art, the following provides a brief description of the accompanying drawings used for implementation. The drawings represent only exemplary embodiments, and various alternative configurations can be devised by those skilled in the art without inventive effort.

FIG. 1 is a schematic diagram of an cart without a mobile wheel.

FIG. 2 is a schematic diagram of a cart according to some aspects of the present disclosure.

FIG. 3 is a front view of a mobile wheel structure according to some aspects of the present disclosure.

FIG. 4 is a left-side view of the mobile wheel structure according to some aspects of the present disclosure.

FIG. 5 is a cross-sectional view along section line A-A in FIG. 4 in a non-braking state.

FIG. 6 is a cross-sectional view along section line A-A in FIG. 4 in a braking state.

FIG. 7 is a schematic diagram of a second operating member according to some aspects of the present disclosure.

### REFERENCE NUMERALS

100. cart; 10. mobile wheel structure; 20. storage platform; 201. first storage platform; 202. second storage platform; 2021. crossbeam; 30. support column; 40. handle;
1. connection assembly; 11. quick-release base; 111. clamping block; 12. locking member; 121. locking lever; 122. locking post; 123. locking block; 14. second bearing;
2. wheel assembly; 21. mounting frame; 211. first pivot shaft; 212. frame body; 213. first support arm; 214. second support arm; 22. wheel; 221. wheel bearing; 222. first bearing; 23. braking member; 231. braking portion; 2311. braking end; 2312. fourth pivot shaft; 2313. limit protrusion; 2314. spring; 232. first operating portion; 2321. first operating body; 2322. first trigger protrusion; 2323. second trigger protrusion; 2324. limit groove; 233. second operating portion; 2331. second operating body; 2332. third trigger protrusion; 234. second pivot shaft; 235. third pivot shaft.

The objectives, functional features, and aspects of this disclosure will be further explained with reference to the embodiments and accompanying drawings.

### DETAILED DESCRIPTION

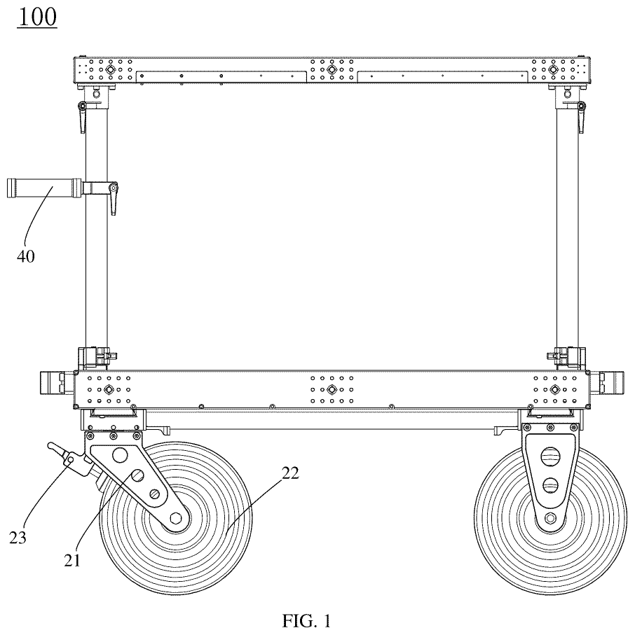

FIG. 1 illustrates a relevant cart, which can be a cart designed for filming purposes. The bottom of the cart body can be equipped with a universal wheel structure (e.g., swivel casters) mounted via a conventional first pivot shaft, allowing omnidirectional rotation of the wheels. To accommodate the swivel requirements of the universal wheels, the conventional mounting frame 21 typically includes an inclined portion. This inclined configuration causes the wheel bearing of the wheel 22 to deviate from the axial direction of the first pivot shaft 211, enabling flexible directional changes of the wheel 22. During use, it is observed that the inclined structure causes the wheel 22 to behave differently depending on the direction of movement. From the perspective of FIG. 1, when the wheel 22 is pulled, the conventional braking member 23 remains in the state shown in FIG. 1. However, when the wheel 22 is pushed, it tends to rotate around the pivot shaft, causing the braking member 23 to retract beneath the cart body. Since filming carts are predominantly used in a pushed state, this design makes operation of the brake inconvenient for users.

Consequently, when using the cart 100 to transport items, the user must pull the cart before each braking operation to expose the braking member 23. However, pulling the cart 100 is generally more cumbersome than pushing it. Thus, the cart design shown in FIG. 1 results in poor usability.

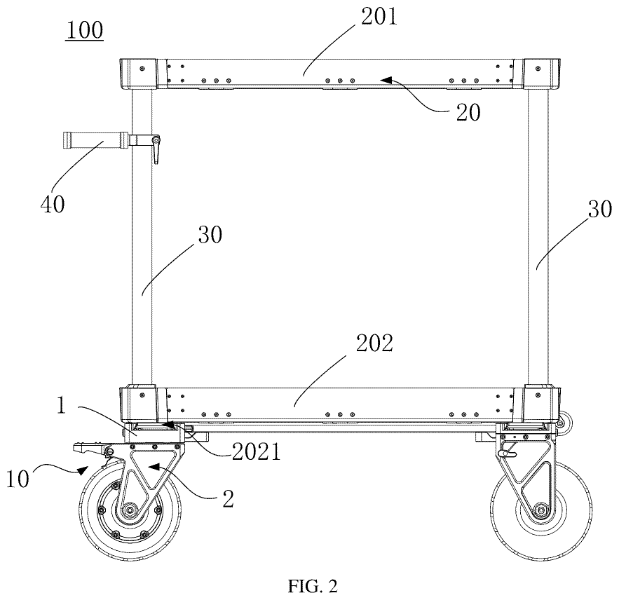

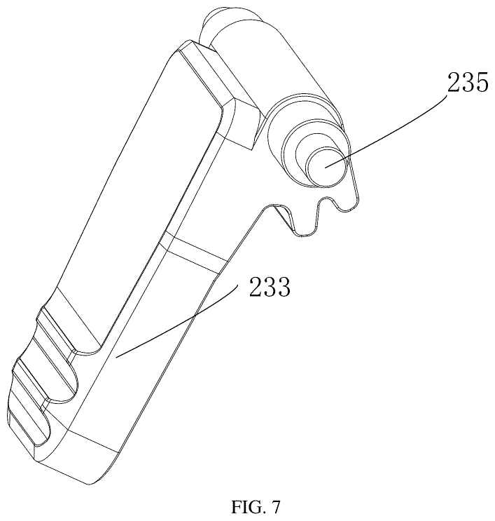

Referring to FIGS. 2-7, the present disclosure discloses a cart 100 including multiple storage platforms 20, support columns 30, and the aforementioned mobile wheel structure 10. The storage platforms 20 can incorporate a first storage platform 201 and a second storage platform 202. The support column 30 is connected at one end to the first storage platform 201 and at the other end to the second storage platform 202. The connection assembly 1 is pivotally attached to the side (e.g., a side facing downward) of the second storage platform 202 opposite the first storage platform 201.

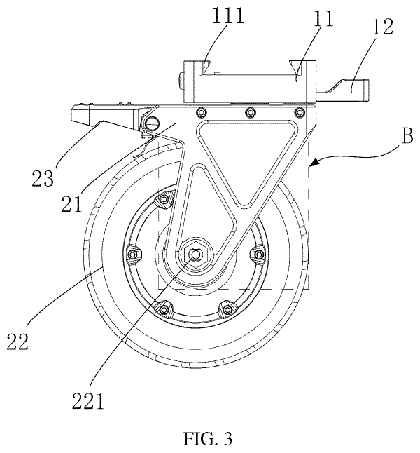

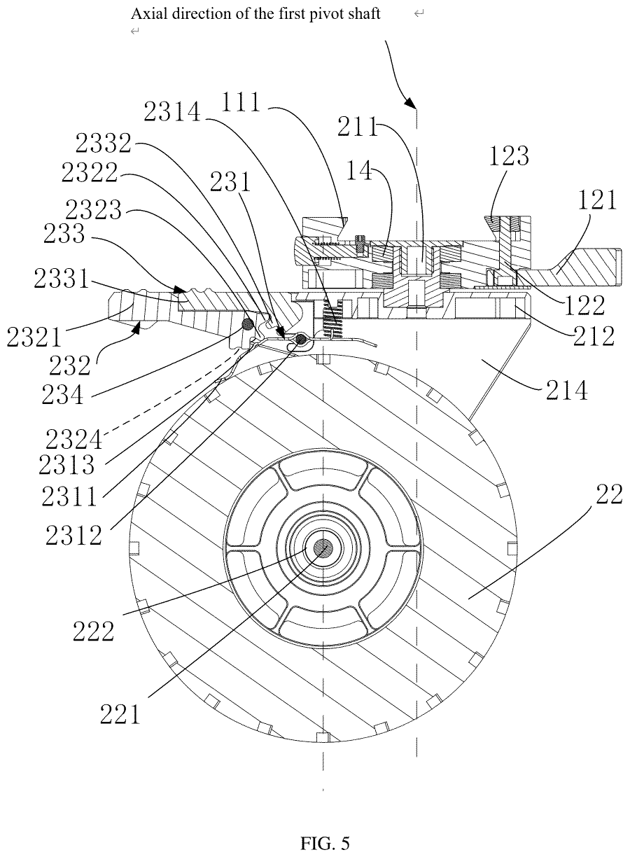

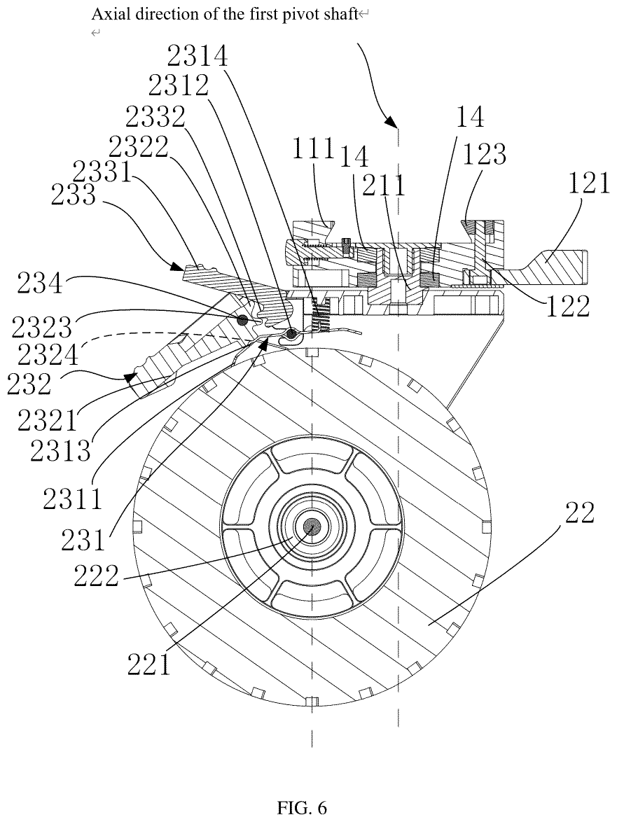

Referring to FIGS. 3-7, the mobile wheel structure 10 can include a connection assembly 1 and a wheel assembly 2. The wheel assembly 2 includes a mounting frame 21, a wheel 22, and a braking member 23. The mounting frame 21 is pivotally connected to the connection assembly 1 via the first pivot shaft 211, and its inclined structure extends to connect with the wheel bearing 221 of the wheel 22, ensuring that the wheel bearing 221 deviates (offset) from the axial direction of the first pivot shaft 211. The braking member 23 is pivotally connected to the mounting frame 21, with both the braking member 23 and the wheel bearing 221 positioned on the same side (lateral side) of the first pivot shaft 211, as shown in FIGS. 5-6.

The phrase “the braking member 23 and the wheel bearing 221 are positioned on the same side of the first pivot shaft 211” indicates that both the braking member 23 and the wheel bearing 221 are located on the same side of the first pivot shaft 211 in the axial direction. For instance, in the views presented in FIGS. 5 and 6, both the braking member 23 and the wheel bearing 221 are situated on the left side of the first pivot shaft 211 in the axial direction.

In some aspects, the mounting frame 21 includes an obliquely extending portion, with the braking member 23 and the wheel bearing 221 positioned on the same side of the first pivot shaft 211. Thus, during use, when the user pushes the cart 100, the wheel 22 rotates relative to the wheel bearing 221, and the mounting frame 21 rotates along with the wheel 22 relative to the connection assembly 1, tilting outward to position the wheel 22 outside the cart 100. Since the braking member 23 and the wheel bearing 221 are on the same side of the first pivot shaft 211, the braking member 23 remains outside the cart 100, simplifying the user's operation of the braking member 23 to brake the wheel 22.

In some aspects, pushing the cart 100 is generally easier than pulling it. In cases where the user pulls the cart, causing the braking member 23 to be beneath the cart 100, a slight push can reposition the braking member 23 outside (extending outward from) the cart 100 for easy access to the braking member 23.

In some aspects, a first bearing 222 can be installed between the wheel 22 and the wheel bearing 221 to facilitate smooth rotation of the wheel 22. A second bearing 14 can also be fitted over the first pivot shaft 211 to enhance the mobility between the connection assembly 1 and the mounting frame 21.

In some aspects, the cart 100 can include a handle 40, and the connection assembly 1 can be attached to the second storage platform 202. When the user pushes the cart 100, the mounting frame 21 pivots relative to the second storage platform 202, tilting outward to position the wheel 22 outside (at least partially) the cart 100. Since the braking member 23 and the wheel bearing 221 are on the same side of the first pivot shaft 211, the braking member 23 remains outside the cart 100, simplifying the user's operation of the braking member 23 to brake the wheel 22. Multiple mobile wheel structures 10 can be installed, and the connection assemblies 1 of the multiple mobile wheel structures 10 are connected to the side of the second storage platform 202 opposite to the first storage platform 201—for example, omnidirectional mobile wheel structures 10 (e.g., swivel casters) at the four corners of the second storage platform 202, or two omnidirectional mobile wheel structures 10 at one end of the bottom of the second storage platform 202 and two fixed wheels 22 at the other end, as illustrated in FIG. 2.

As shown in FIGS. 2 and 5-6, the second storage platform 202 can include a crossbeam 2021, and the connection assembly 1 includes a quick-release base 11 and a locking member 12. The end of the support column 30 away from the first storage platform 201 connects to the second storage platform 202, and the crossbeam 2021 is attached to the side of the second storage platform 202 away from the first storage platform 201. The quick-release base 11 is connected to the crossbeam 2021, and the locking member 12 is positioned on the quick-release base 11, locking the quick-release base 11 onto the crossbeam 2021. The mounting frame 21 is pivotally connected to the quick-release base 11 via the first pivot shaft 211. In some aspects, the connection assembly 1 can simply be a connecting block fixed to the underside of the second storage platform 202.

The quick-release mechanism operates as follows. The locking member 12 includes a locking lever 121, a locking post 122, and a locking block 123, while the quick-release base 11 includes a clamping block 111. The clamping block 111 and locking block 123 are positioned opposite each other. The locking lever 121 is threaded onto the locking block 123 via the locking post 122. Rotating the locking lever 121 drives the locking block 123 toward the quick-release base 11, clamping the crossbeam 2021 between the clamping block 111 and locking block 123 for rapid installation of the quick-release base 11 and the crossbeam 2021. To release, the locking lever 121 is flipped open, retracting the locking block 123 away from the quick-release base 11 relative to the locking post 122 and freeing the crossbeam 2021 for rapid removal of the quick-release base 11 and the crossbeam 2021.

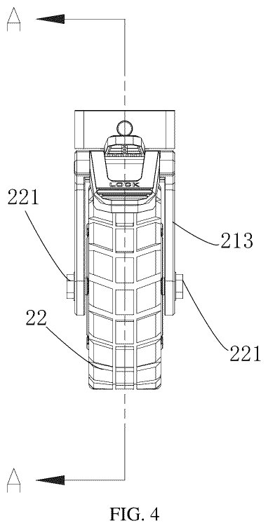

In some aspects, referring to FIGS. 4 and 5, the mounting frame 21 includes a frame body 212, a first support arm 213, and a second support arm 214. The first and second support arms 213, 214 are attached to the frame body 212, and the ends of the wheel bearing 221 are connected to their distal ends away from the frame body 212. The inclined arrangement of the first and second support arms 213, 214 ensures that the wheel bearing 221 deviates from the axial direction of the first pivot shaft 211. The braking member 23 is movably connected to the frame body 212.

Referring to FIGS. 4-6, the braking member 23 includes a braking portion 231 and a first operating portion 232. The first operating portion 232 is movably connected to the mounting frame 21, and the braking portion 231 is also movably connected to the mounting frame 21, with one end elastically connected to the mounting frame 21 and the other end provided with a braking end 2311. The first operating portion 232 can trigger the braking end 2311, causing the wheel 22 to brake. With this arrangement, when the user needs to brake the wheel 22, they can step on the first operating portion 232, causing it to press against the braking end 2311, which in turn abuts against the wheel 22 to achieve braking. When the user lifts their foot to raise the first operating portion 232, the first operating portion 232 releases its pressure on the braking end 2311, allowing the braking end 2311 to disengage from the wheel 22, thereby enabling the user to push the cart 100 and the wheel 22 to rotate. In some aspects, the braking portion 231 can be movably connected to the mounting frame 21 via a fourth pivot shaft 2312.

In some aspects, this disclosure presents a more effective method for braking and releasing the brake. Referring to FIGS. 5-7, the mobile wheel further includes a second operating portion 233, which is also movably connected to the mounting frame 21. The first operating portion 232 and the second operating portion 233 cooperate to enable the first operating portion 232 to trigger or release the triggering of the braking end 2311, thereby braking or releasing the brake on the wheel 22. For example, the first operating portion 232 is movably connected to the mounting frame 21 via a second pivot shaft 234, and the second operating portion 233 is movably connected to the mounting frame 21 via a third pivot shaft 235. When the first operating portion 232 rotates around the second pivot shaft 234 in a first direction, it causes the second operating portion 233 to rotate around the third pivot shaft 235 in a second direction, and the first operating portion 232 can trigger the braking end 2311 causing the wheel 22 to brake. Conversely, when the second operating portion 233 rotates around the third pivot shaft 235 in the first direction, it causes the first operating portion 232 to rotate around the second pivot shaft 234 in the second direction, thereby releasing the brake from the wheel 22. It should be noted that the first direction refers to the counterclockwise rotation direction as shown in FIGS. 5 and 6 (i.e., the direction in which the user steps down), while the second direction refers to the clockwise rotation direction as shown in FIGS. 5 and 6. When the viewing angle changes, the first and second directions adjust accordingly. With this arrangement, when the cart stops moving, the user can step on the first operating portion 232, causing it to press against the braking end 2311, which in turn presses against the wheel 22 to apply braking. When the user wishes to resume pushing the cart 100, the user can step on the second operating portion 233, causing it to rotate in the first direction, which triggers the first operating portion 232 to release its pressure on the braking end 2311, thereby disengaging the braking end 2311 from the wheel 22 and releasing the brake on the wheel 22. In summary, the braking and brake-release operations in this solution are simple, convenient, and rapid.

Referring to FIGS. 5-6, the first operating portion 232 includes a first operating body 2321, along with a first trigger protrusion 2322 and a second trigger protrusion 2323 positioned at the head of the first operating body 2321. The second operating portion 233 includes a second operating body 2331 and a third trigger protrusion 2332 located at the head of the second operating body 2331.

When the first operating body 2321 rotates in the first direction around the second pivot shaft 234, it can press against the braking end 2311 to apply braking to the wheel 22. Concurrently, this rotation causes the first trigger protrusion 2322 to abut against the second operating body 2331, prompting it to rotate in the second direction around the third pivot shaft 235. This design enables the user to step on the first operating body 2321, causing it to press against the braking end 2311, which in turn presses against the wheel 22 to apply braking. Moreover, the rotation of the first operating body 2321 around the second pivot shaft 234 in the first direction enables the second operating body 2331 to rotate around the third pivot shaft 235, thereby facilitating brake release.

When the second operating body 2331 rotates in the first direction around the third pivot shaft 235, the third trigger protrusion 2332 can press against the second trigger protrusion 2323, inducing the first operating body 2321 to rotate in the second direction around the second pivot shaft 234, thus releasing the brake on the wheel 22. To release the brake, the user can step on the second operating body 2331, causing it to rotate in the first direction around the third pivot shaft 235. The third trigger protrusion 2332 of the second operating body 2331 then presses against the second trigger protrusion 2323 of the first operating body 2321, causing the first operating body 2321 to rotate in the second direction around the second pivot shaft 234. This action relieves the pressure exerted by the first operating body 2321 on the braking end 2311, allowing the braking end 2311 to disengage from the wheel 22 and complete the brake release. In some aspects, as depicted in FIGS. 5-6, when the user steps on the second operating body 2331 and the third trigger protrusion 2332 abuts against the second trigger protrusion 2323, the second trigger protrusion 2323 rotates in the second direction. During this process, the first operating body 2321 initially applies a slight downward pressure on the braking end 2311 before moving away from it.

In some aspects, referring again to FIGS. 5-6, one of the opposing sides of the braking end 2311 and the first operating portion 232 can be equipped with a limit protrusion 2313, while the other side is provided with a limit groove 2324. When the user steps on the first operating portion 232, causing it to abut against the braking end 2311, the limit protrusion 2313 can fit into the limit groove 2324, ensuring positional alignment between the first operating portion 232 and the braking end 2311.

What is claimed is:

1. A mobile wheel structure, comprising:
a connection assembly; and
a wheel assembly comprising a mounting frame, a wheel, and a braking member, wherein the mounting frame is pivotally connected to the connection assembly via a first pivot shaft, and a portion of the mounting frame extends obliquely to connect to a wheel bearing of the wheel, enabling the wheel bearing to be offset from an axial direction of the first pivot shaft; and
wherein the braking member is movably connected to the mounting frame, and the braking member and the wheel bearing are provided on a same side of the first pivot shaft.

2. The mobile wheel structure according to claim 1, wherein the mounting frame comprises a frame body, a first support arm, and a second support arm;
wherein the first support arm and the second support arm are connected to the frame body, and two ends of the wheel bearing of the wheel are respectively connected to distal ends of the first support arm and the second support arm away from the frame body;
wherein the first support arm and the second support arm are inclined with respect to the frame body, enabling the wheel bearing to be offset from the axial direction of the first pivot shaft; and
wherein the braking member is movably connected to the frame body.

3. The mobile wheel structure according to claim 1, wherein the braking member comprises a braking portion and a first operating portion;
wherein the first operating portion is movably connected to the mounting frame;
wherein the braking portion is movably connected to the mounting frame, with one end elastically connected to the mounting frame and another end provided with a braking end; and
wherein the first operating portion is configured to actuate the braking end to press against the wheel, thereby causing the wheel to brake.

4. The mobile wheel structure according to claim 3, further comprising a second operating portion that is movably connected to the mounting frame; and
wherein the first operating portion and the second operating portion cooperate to enable the first operating portion to engage the braking end to brake the wheel, or disengage the braking end to release the wheel.

5. The mobile wheel structure according to claim 4, wherein the first operating portion is pivotally connected to the mounting frame via a second pivot shaft;
wherein the second operating portion is pivotally connected to the mounting frame via a third pivot shaft;
wherein in response to the first operating portion rotating about the second pivot shaft in a first direction, the braking end is configured to actuate to apply braking to the wheel, and drive the second operating portion to rotate about the third pivot shaft in a second direction; and
wherein in response to the second operating portion rotating about the third pivot shaft in the first direction, the first operating portion is configured to rotate about the second pivot shaft in the second direction, releasing braking of the wheel.

6. The mobile wheel structure according to claim 5, wherein the first operating portion comprises a first operating body, a first trigger protrusion, and a second trigger protrusion;
wherein the first trigger protrusion and the second trigger protrusion are provided at a head of the first operating body;
wherein the second operating portion comprises a second operating body and a third trigger protrusion;
wherein the third trigger protrusion is provided at a head of the second operating body;
wherein in response to the first operating body rotating about the second pivot shaft in the first direction, the braking end brakes the wheel, and the first trigger protrusion abuts the second operating body to drive the second operating body to rotate about the third pivot shaft in the second direction; and
wherein in response to the second operating body rotating about the third pivot shaft in the first direction, the third trigger protrusion abuts the second trigger protrusion to rotate about the second pivot shaft in the second direction, driving the first operating body to release braking of the wheel.

7. The mobile wheel structure according to claim 3, wherein one of opposing surfaces of the first operating portion and the braking end is provided with a limit protrusion, and another is provided with a limit groove; and
wherein in response to the first operating portion pressing against the braking end, the limit protrusion engages the limit groove.

8. A cart comprising multiple storage platforms, a support column, and the mobile wheel structure according to claim 1;
wherein the multiple storage platforms comprise a first storage platform and a second storage platform;
wherein one end of the support column is connected to the first storage platform, and another end is connected to the second storage platform; and
wherein the connection assembly is connected to a side of the second storage platform opposite to the first storage platform.

9. The cart according to claim 8, wherein a bottom of the second storage platform comprises a crossbeam;
wherein the connection assembly comprises a quick-release base and a locking member;
wherein the quick-release base is connected to the crossbeam, and the locking member is disposed on the quick-release base to lock the quick-release base to the crossbeam; and
wherein the mounting frame is pivotally connected to the quick-release base via the first pivot shaft.

10. The cart according to claim 8, further comprising one or more mobile wheel structures,
wherein the connection assembly of each of the one or more mobile wheel structures is connected to a side of the second storage platform opposite to the first storage platform.
